(19) United States
(12) Patent Application Publication
(10) Pub. No.: US 2017/0212535 A1
(43) Pub. Date: Jul. 27, 2017

(54) FIELD PRESSURE TEST CONTROL SYSTEM AND METHODS

(71) Applicant: S.P.M. FLOW CONTROL, INC., FORT WORTH, TX (US)

(72) Inventors: Joshua Shelman, San Antonio, TX (US); Cody Hurst, Castroville, TX (US)

(21) Appl. No.: 15/411,300

(22) Filed: Jan. 20, 2017

Related U.S. Application Data
(60) Provisional application No. 62/281,319, filed on Jan. 21, 2016.

(51) Int. Cl. G05D 16/20; E21B 41/00; E21B 34/00; G01M 3/28

(52) U.S. Cl. CPC G05D 16/2013; G01M 3/2807; E21B 41/00; E21B 34/00; E21B 43/26

(57) ABSTRACT

A field pressure test control system is adapted to be coupled to high pressure tubing through which fluid is pumped to a wellhead. When the system is coupled to the tubing and an isolation valve is open, the tubing is in fluid communication with a fluid line via at least the isolation valve. A sensor detects pressure in the fluid line during pressure testing of the high pressure tubing, and a relief valve is opened to permit fluid flow through the relief valve and thus lower pressure in the high pressure tubing. A pressure testing method includes closing the wellhead, and pumping fluid into the high pressure tubing and the fluid line. A fluid pressure in the fluid line is detected, and a relief valve is remotely opened to lower the fluid pressure. In several exemplary embodiments, the pressure testing is completed before a hydraulic fracturing operation begins.

### CROSS-REFERENCE TO RELATED APPLICATIONS

This application claims the benefit of the filing date of, and priority to, U.S. patent application No. 62/281,319, filed Jan. 21, 2016, the entire disclosure of which is hereby incorporated herein by reference.

This application is related to U.S. patent application Ser. No. 15/005,438, filed Jan. 25, 2016, which is a continuation of U.S. patent application Ser. No. 13/964,863, filed Aug. 12, 2013, now U.S. Pat. No. 9,273,543, issued Mar. 1, 2016, which is a continuation-in-part of U.S. patent application Ser. No. 13/886,771, filed May 3, 2013, now U.S. Pat. No. 9,322,243, issued Apr. 26, 2016, which claims priority to and the benefit of the filing date of U.S. patent application No. 61/684,394, filed Aug. 17, 2012, the entire disclosures of which are hereby incorporated herein by reference.

### TECHNICAL FIELD

This disclosure relates in general to a field pressure test control system and, in particular, to a field pressure test control system for pressure testing a system associated with a wellhead, such as a system for pumping fluid to a wellhead.

### BACKGROUND OF THE DISCLOSURE

Hydraulic fracturing to stimulate a subterranean formation includes injecting a fracturing fluid through a wellbore into the formation at a pressure and flow rate at least sufficient to overcome the pressure of the reservoir and extend fractures into the formation. A high pressure line directs the fracturing fluid through a wellhead and into the wellbore. The fracturing fluid is a mixture of a liquid and a media, and is typically injected into the wellbore at high pressures, in the range of about 10,000 to about 30,000 psi.

To protect the integrity of the wellhead and to reduce equipment failures, such as blown tubing or pumps, pressure testing of a system for pumping fluid to the wellhead, and/or components thereof, is conducted before a hydraulic fracturing operation begins, that is, before the fluid is pumped to the wellhead to hydraulically fracture the wellbore. This pressure testing is conducted to ensure that the system and/or components thereof can withstand the high pressures experienced during the pumping of the fluid to the wellhead. However, it is typical for a human operator to operate one or more manual valves to relieve pressure during and/or after the pressure testing, potentially increasing the risk of injury to the operator. Therefore, what is needed is a system or method that addresses one or more of the foregoing issues, and/or other issue(s).

### SUMMARY

In a first aspect, there is provided a field pressure test control system adapted to be operably coupled to high pressure tubing through which fluid is pumped to a wellhead. The field pressure test control system includes a first isolation valve adapted to be in fluid communication with the high pressure tubing; a first fluid line adapted to be in fluid communication with the high pressure tubing via at least the first isolation valve; a sensor adapted to detect pressure in the first fluid line during pressure testing of the high pressure tubing; and a pressure relief valve adapted to be in fluid communication with the high pressure tubing via at least the first fluid line and the first isolation valve; wherein the pressure relief valve is adapted to change from a closed state to an open state to permit fluid flow through the pressure relief valve and thus lower pressure in the high pressure tubing after the pressure testing of the high pressure tubing.

In an exemplary embodiment, the field pressure test control system includes a controller adapted to remotely control the change of the pressure relief valve from the closed state to the open state; wherein the control of the change of the pressure relief valve from the closed state to the open state is at least partially based on the detected pressure in the first fluid line.

In another exemplary embodiment, the controller is configured to have a pressure threshold stored therein.

In yet another exemplary embodiment, the controller remotely controls the change of the pressure relief valve from the closed state to the open state when the detected pressure in the first fluid line is substantially equal to the pressure threshold for a desired duration of time.

In still yet another exemplary embodiment, the controller is adapted to be in communication with the sensor; wherein the controller is configured to receive from the sensor data associated with the detected pressure in the first fluid line, and to compare the data with the pressure threshold; and wherein the controller remotely controls the change of the pressure relief valve from the closed state to the open state when either: the detected pressure exceeds the pressure threshold; or the detected pressure in the first fluid line is substantially equal to the pressure threshold for a desired duration of time.

In certain exemplary embodiments, the controller is adapted to be positioned at a location that is equal to, or greater than, 15 feet away from the pressure relief valve.

In an exemplary embodiment, the field pressure test control system includes a second isolation valve adapted to be in fluid communication with the first fluid line; and a second fluid line adapted to be in fluid communication with each of the pressure relief valve, the second isolation valve, and a fluid reservoir; wherein the second isolation valve is closed during the pressure testing of the high pressure tubing so that, after the pressure testing of the high pressure tubing, the fluid flows through the relief valve, through the second fluid line, and to the fluid reservoir.

In another exemplary embodiment, the field pressure test control system includes a skid upon which at least the pressure relief valve, the second isolation valve, and at least a portion of the second fluid line are mounted.

In yet another exemplary embodiment, the field pressure test control system includes a choke adapted to be fluidically positioned between the first isolation valve and the relief valve; wherein the choke is adapted to absorb forces caused by the fluid flow through the pressure relief valve, thereby reducing wear on the pressure relief valve.

In a second aspect, there is provided a method of pressure testing high pressure tubing through which fluid is adapted to be pumped to a wellhead. The method includes: closing the wellhead; after closing the wellhead, pumping fluid into the high pressure tubing and into a fluid line that is in fluid communication with the high pressure tubing; detecting a fluid pressure in the fluid line; and remotely opening a relief valve so that the fluid flows through the relief valve, thereby lowering the fluid pressure in the fluid line and thus fluid pressure in the high pressure tubing.

In an exemplary embodiment, the method includes: opening an isolation valve so that the high pressure tubing is in fluid communication with the fluid line via at least the isolation valve, wherein the isolation valve is opened before the fluid is pumped into the high pressure tubing and the fluid line; and closing the isolation valve to fluidically isolate the high pressure tubing from the relief valve, wherein the isolation valve is closed after the relief valve is remotely opened.

In another exemplary embodiment, the method includes opening the wellhead; wherein the isolation valve is closed before the wellhead is opened.

In yet another exemplary embodiment, the method includes absorbing, using a choke in fluid communication with the relief valve, forces caused by the fluid flow through the relief valve, thereby reducing wear on the relief valve.

In still yet another exemplary embodiment, remotely opening the relief valve includes remotely opening the relief valve when the detected pressure in the fluid line is substantially equal to a fluid pressure threshold for a desired duration of time.

In certain exemplary embodiments, remotely opening the relief valve includes: remotely receiving sensor data associated with the detected pressure in the fluid line; remotely comparing the sensor data with a pressure threshold; and remotely opening the relief valve when either: the detected pressure exceeds the pressure threshold; or the detected pressure in the first fluid line is substantially equal to the pressure threshold for a desired duration of time.

In a third aspect, there is provided a method of lowering pressure in high pressure tubing through which fluid is adapted to be pumped to a wellhead. The method includes: connecting an isolation valve to the high pressure tubing; closing the wellhead; after closing the wellhead, opening the isolation valve so that the high pressure tubing is in fluid communication with a pressure relief valve; after opening the isolation valve, detecting pressure in a fluid line, the fluid line being in fluid communication with the high pressure tubing via at least the open isolation valve; and remotely controlling the pressure relief valve to lower the pressure in the high pressure tubing; wherein the remote control of the pressure relief valve is based on at least the pressure detected in the fluid line.

In an exemplary embodiment, the method includes: closing the isolation valve; and after closing the isolation valve, opening the wellhead.

In another exemplary embodiment, remotely controlling the pressure relief valve includes remotely opening the pressure relief valve to permit fluid to flow through the pressure relief valve.

In yet another exemplary embodiment, the method includes absorbing, using a choke in fluid communication with the relief valve, forces caused by the fluid flow through the relief valve, thereby reducing wear on the pressure relief valve.

In still yet another exemplary embodiment, remotely opening the relief valve includes: remotely receiving sensor data associated with the detected pressure in the fluid line; remotely comparing the sensor data with a pressure threshold; and remotely opening the relief valve when either: the detected pressure exceeds the pressure threshold; or the detected pressure in the first fluid line is substantially equal to the pressure threshold for a desired duration of time.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF FIGURES

The accompanying drawings facilitate an understanding of the various embodiments.

FIG. 1 is a diagrammatic illustration of a hydraulic fracturing site (“frac site”), according to an exemplary embodiment of the present disclosure.

FIG. 2 is a diagrammatic illustration of a relief valve system, according to an exemplary embodiment of the present disclosure.

FIG. 3 is a diagrammatic illustration of a field pressure test control system according to an exemplary embodiment of the present disclosure, the field pressure test control system including components of the relief valve system of FIG. 2.

FIG. 4 is a perspective view of a portion of the field pressure test control system of FIG. 3, according to an exemplary embodiment of the present disclosure.

FIG. 5 is a flow chart illustration of a method of pressure testing high pressure tubing through which fluid is adapted to be pumped to a wellhead, according to an exemplary embodiment of the present disclosure.

### DETAILED DESCRIPTION

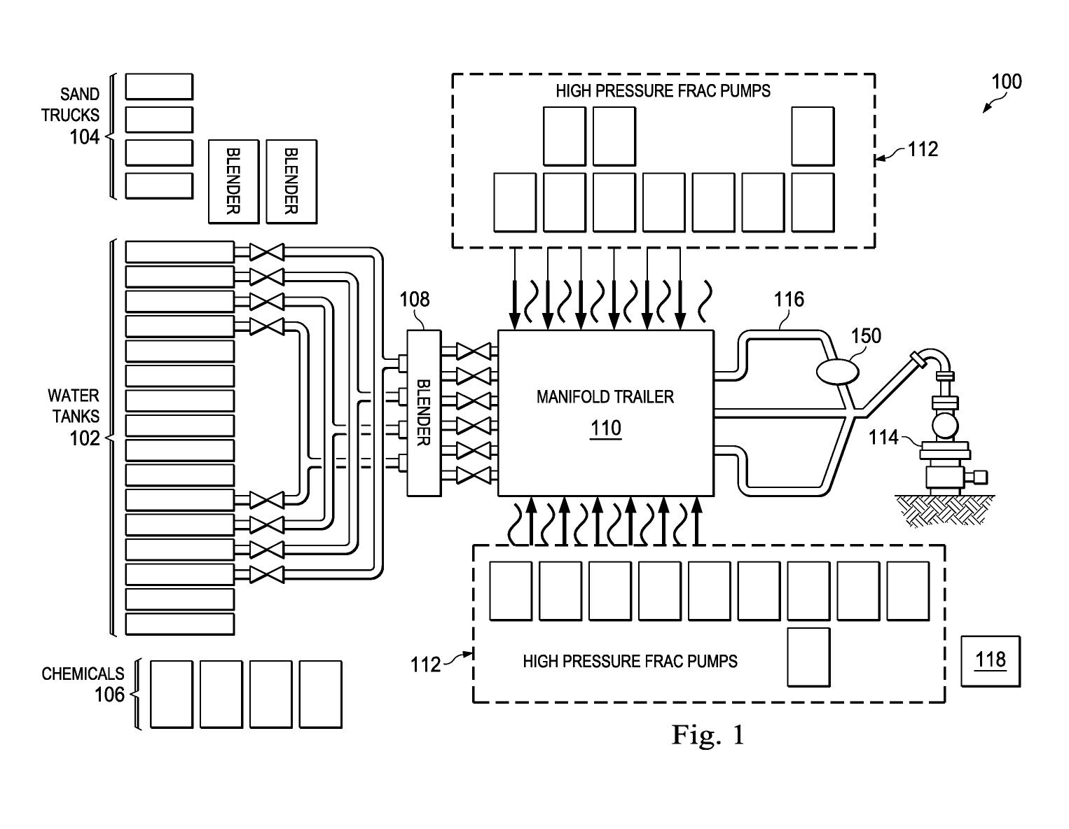

FIG. 1 illustrates an exemplary frac site incorporating subject matter of the present disclosure. The frac site, referenced herein by the numeral 100, includes water trucks 102, sand trucks 104, chemicals 106, a blender 108, a manifold trailer 110, and high pressure frac pumps 112. The water, sand, and chemicals are introduced into the blender 108 to create slurry referenced herein as a fracturing or fracing fluid. The fracing fluid is introduced into the manifold trailer 110, and fed from the manifold trailer 110 to high pressure frac pumps 112.

The manifold trailer 110 includes a low pressure section and a high pressure section. The low pressure section transfers low pressure from the blender 108 to the frac pumps 112. The high pressure section transfers the fracing fluid from the frac pumps 112 to a wellhead 114. The high pressure frac pumps 112 receive the mixed fluid from the manifold trailer 110 through respective suction manifolds and energize the fluid through respective fluid ends of the frac pumps 112. Depending on the capacity of each of the frac pumps 112, this pressure can reach up to about 15,000 to about 30,000 psi. The high pressure fracing fluid is directed from the manifold trailer 110 to the wellhead 114 via a high pressure tubing 116.

In the example of FIG. 1, the frac site 100 includes a data van 118 that operates as a main communication center for the entire frac site 100. The data van 118 may be configured to monitor all aspects of the fracing operation and may be in communication with transducers and controllers disposed about the frac site 100. From the data van 118, an operator may be able to remotely monitor pressures, flows, blending, and other information relating to the frac site 100.

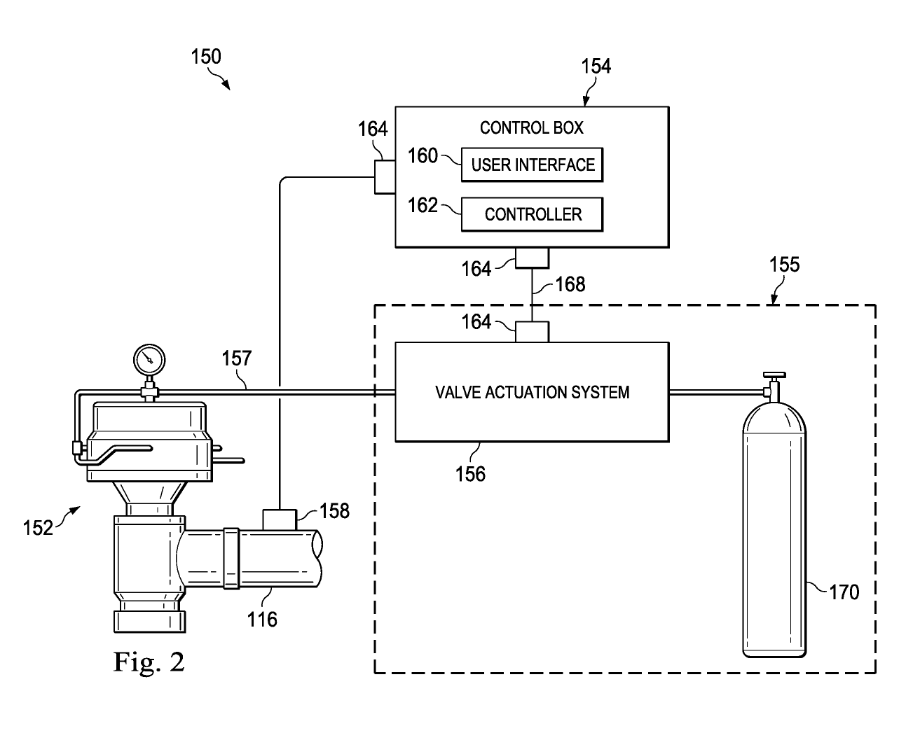

The exemplary frac site in FIG. 1 includes a relief valve system 150 configured to monitor pressure in the high pressure tubing 116 and configured to relieve system pressure in the event of over-pressurization from the pumps 112 or the wellhead 114. The relief valve system 150 is described in greater detail with reference to FIG. 2.

FIG. 2 is a diagrammatic illustration of the relief valve system 150, which includes a relief valve 152, a control box 154, and a regulator unit 155. The regular unit 155 includes a valve actuation system 156 and an actuation fluid source 170; in an exemplary embodiment, the actuation fluid source 170 is a gas source such as, for example, one or more nitrogen tanks. The relief valve 152 is disposed along the high pressure tubing 116 and may relieve system pressure in the event of over-pressurization from the frac pumps 112 or the wellhead 114. As such, it may provide over-pressure protection for reciprocating pumps, treating lines, pressure vessels, and other equipment operating under high-pressure, high-flow conditions.

In several exemplary embodiments, instead of, or in addition to, one or more nitrogen tanks, the actuation fluid source 170 includes one or more other gas sources such as, for example, one or more compressors that provide compressed air, one or more air tanks, one or more other gas bottles, cartridges or tanks, one or more accumulators, or any combination thereof. In several exemplary embodiments, the actuation fluid source 170 includes one or more pumps. In several exemplary embodiments, the actuation fluid source 170 includes one or more of several types of pressurized fluid sources.

In an exemplary embodiment, the actuation fluid source 170 is a self-contained, pressurized gas source, the operation of which causes almost no moisture, or only small amounts of moisture or negligible moisture, to be present in the actuation fluid source 170, the valve actuation system 156, and the connection therebetween; as a result, the risk of corrosion and/or freezing is reduced. Since the actuation fluid source 170 is a self-contained pressurized gas source, pumps, compressors, or the like are not required; in several exemplary embodiments, such a self-contained pressurized gas source includes one or more nitrogen tanks. In several exemplary embodiments, such a self-contained pressurized gas source includes one or more nitrogen tanks and, as a result, the water content of the compressed nitrogen is about 0.003% by volume (in contrast, the water content in compressed air is about 2% by volume).

A pressure sensor 158 is arranged on the high pressure tubing 116 to detect pressure therein. In some embodiments, the pressure sensor 158 may be disposed at the inlet of the pressure relief valve 152, adjacent the pressure relief valve 152, or at other locations. The pressure sensor 158 may be any type of pressure sensor and in different embodiments may include one or more of piezoelectric sensors, capacitive sensors, electromagnetic sensors, potation sensors, thermal sensors, resonant sensors, among others. In one embodiment, it is an intrinsically safe pressure transducer. The sensor 158 may be configured to provide electronic dampening of the signal to reduce false readings due to pressure pulsations. In an exemplary embodiment, the sensor 158 is an intrinsically safe, high sampling rate pressure transducer, the signals or data transmission from which may be dampened, as will be described in further detail below.

The control box 154 allows an operator to have direct access to data collected by the pressure sensor 158 and the valve actuation system 156. In some embodiments, the control box 154 is disposed within the data van 118 or some other structure that is positioned remotely, or spaced apart, from the pressure relief valve 152. It may be powered by any power source, and in some embodiments, is powered by 110AC. The control box 154 may include a user interface 160 and a controller 162. In some embodiments, the user interface 160 includes a combined display and input system, such as, for example, a touch screen LCD. However, other embodiments use alternative user interfaces, including, for example, a separate display screen and a separate input system, including, for example, a keyboard, mouse, trackball, joystick, or other user input device. The user interface 160 may also include other elements including, for example, a speaker, a power switch, an emergency stop switch, and a strobe or alarm light. In an exemplary embodiment, the user interface 160 and the controller 162 may be disposed in the data van 118, and may be powered by a back-up power supply disposed in the data van 188 (such as a DC power supply) if the primary power source fails. In several exemplary embodiments, the control box 154 or components thereof include a backup power supply. In several exemplary embodiments, the back-up power supply is a battery. In the event of a power outage, such as an outage in the data van 118, the backup power supply will be enabled and will power the system.

The controller 162 may include a processor and memory and may be configured to remotely detect, monitor, and control the relief valve system 150. In some embodiments the processor is an integrated circuit with power, input, and output pins capable of performing logic functions. The processor may control different components performing different functions. The memory may be a semiconductor memory that interfaces with the processor. In one example, the processor can write data and commands to and read data and commands from the memory. For example, the processor can be configured to detect, read, or receive data from the pressure sensor 158 and write that data to the memory. In this manner, a series of detected or tracked pressure readings can be stored in the memory. The processor may be also capable of performing other basic memory functions, such as erasing or overwriting the memory, detecting when the memory is full, and other common functions associated with managing semiconductor memory. In an exemplary embodiment, the controller 162 includes an internal timer, which is configured to start and run for a predetermined increment of time, under conditions to be described in further detail below.

The control box 154 may also include a plurality of connectors 164 allowing connection to other components of the relief valve system 150, such as the valve actuation system 156 and the sensor 158. Although any suitable connectors may be used, one embodiment of a suitable connector includes a Circular MIL Spec 32P18 Wall mount socket connector. Other embodiments include a wireless connector including a transmitter and receiver that receives and transmits data to the valve actuation system 156. In one wired embodiment, the connector 164 may connect to the valve actuation system 156 using a data cable 168, such as a 150-ft weatherproof data cable. Other cable types and other lengths are contemplated. The 150-ft data cable is sufficient length to extend from the valve actuation system 156 to the control box 154, which may be disposed at a different location at the frac site, such as in the data van 118.

The valve actuation system 156 is used to open and close the relief valve 152 under the control or instruction of the controller 162. It connects to the actuation fluid source 170, such as the nitrogen tank, although other fluids, including other gases or air may be used. Nitrogen from the actuation fluid source 170 provides pressurized actuation fluid that is regulated in the valve actuation system 156 to open the pressure relief valve 152 when, for example, pressure in the high pressure tubing 116 exceeds a pre-stored threshold. The valve actuation system 156 also connects to the relief valve 152 through a tubing referenced herein as a hose 157. Like the control box 154, the valve actuation system 156 includes a connector 164 for connecting to the cable 168 for communication between the control box 154 and the valve actuation system 156. In some embodiments, the valve actuation system 156 may receive data from the sensor 158 and may send the collected data, either before or after processing, to the control box 154.

In some embodiments, the valve actuation system 156 includes a box that contains components configured to direct actuation fluid, such as the nitrogen, to the pressure relief valve 152 to open and close the valve 152. In several exemplary embodiments, the valve actuation system 156 includes an input pressure regulator, a reducing valve, one or more electronic pressure controllers, one or more pressure transmitters, a dump valve, or any combination thereof. In several exemplary embodiments, a pressure, which is equal to or less than the pressure at the actuation fluid source 170, maintains the relief valve 152 in a closed state; additionally, the valve actuation system 156 includes a dump valve which, when opened, releases pressurized actuation fluid (such as nitrogen gas) into the air, resulting in a loss of pressure at the relief valve 152 and thereby allowing the relief valve 152 to open.

In several exemplary embodiments, the valve actuation system 156 includes in whole or in part one or more of the exemplary embodiments of valve actuation systems described and/or illustrated in one or more of the following applications, the entire disclosures of which are hereby incorporated herein by reference: U.S. patent application Ser. No. 15/005,438, filed Jan. 25, 2016; U.S. patent application Ser. No. 13/964,863, filed Aug. 12, 2013, now U.S. Pat. No. 9,273,543, issued Mar. 1, 2016; U.S. patent application Ser. No. 13/886,771, filed May 3, 2013, now U.S. Pat. No. 9,322,243, issued Apr. 26, 2016; and U.S. patent application No. 61/684,394, filed Aug. 17, 2012.

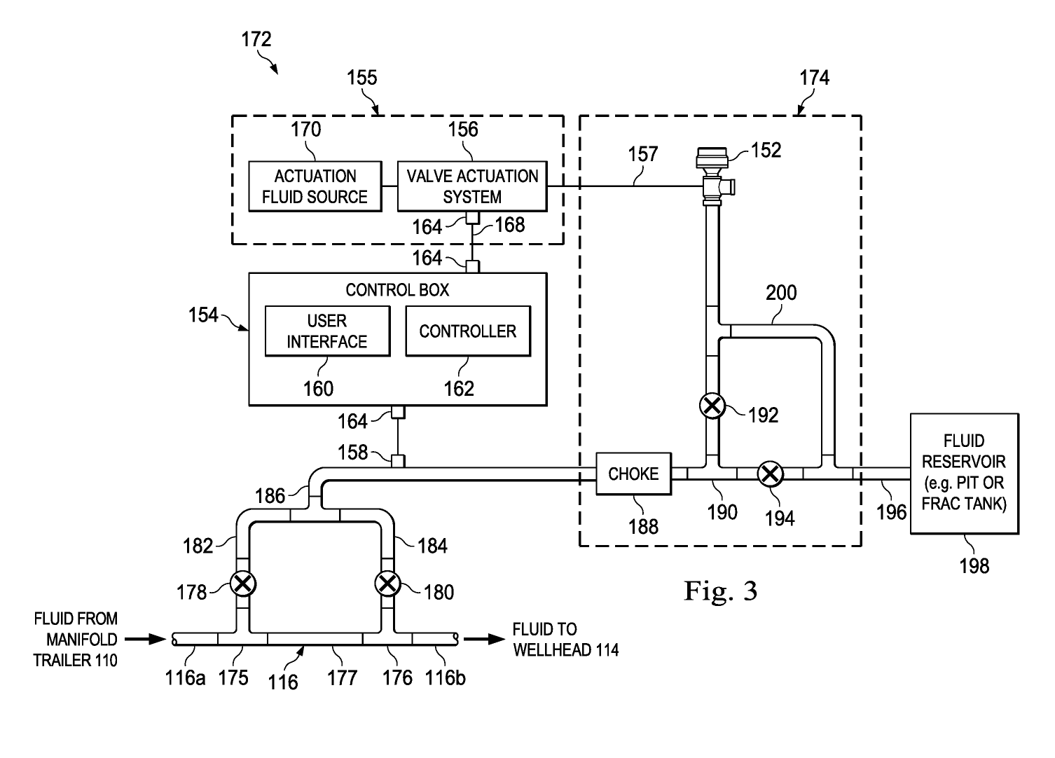

In an exemplary embodiment, as illustrated in FIG. 3 with continuing reference to FIGS. 1 and 2, a field pressure test control system is generally referred to by the reference numeral 172. The field pressure test control system 172 includes components that are identical to at least some components of the frac site 100, including at least some components of the relief valve system 150; these identical components are given the same reference numerals. As shown in FIG. 3, the field pressure test control system 172 includes at least the relief valve 152, the control box 154, the regulator unit 155, the valve actuation system 156, the hose 157, the sensor 158, the user interface 160, the controller 162, the connectors 164, the data cable 168, and the actuation fluid source 170, all of which are interconnected to each other in a manner identical to the manner described above with reference to FIG. 2, except that the sensor 158 of the field test control system 172 is not directly coupled to the high pressure tubing 116.

As shown in FIG. 3, in an exemplary embodiment, the field pressure test control system 172 may be mounted, in whole or in part, on a skid 174. In several exemplary embodiments, the skid 174 may be referred to as a “bleed-off skid.” In several exemplary embodiments, the skid 174 may be characterized as part of the field pressure test control system 172. In several exemplary embodiments, the skid 174 may be characterized as part of the field pressure test control system 172, and the field pressure test control system 172 may be referred to as an “iron package” configured to remotely control the bleed-off of pressure before, during, and/or after different operations such as, for example, during clean water pressure test operations, or after a frac stage; the operation of the field pressure test control system 172 will be described in further detail below.

The field pressure test control system 172 is adapted to be operably coupled to the high pressure tubing 116. More particularly, the field pressure test control system 172 includes tee fittings 175 and 176, and a fluid line 177 extends between the tee fittings 175 and 176. The field pressure test control system 172 is connected to the high pressure tubing 116 of the frac site 100 in an in-line configuration, with the fluid line 177 and the tee fittings 175 and 176 being considered part of the high pressure tubing 116. More particularly, the tee fitting 175 is in fluid communication with the manifold trailer 110 via at least a portion 116a of the high pressure tubing 116 located upstream of the tee fitting 175, and the tee fitting 176 is in fluid communication with the wellhead 114 via at least a portion 116b of the high pressure tubing 116 located downstream of the tee fitting 176. Thus, the field pressure test control system 172 is operably coupled to the high pressure tubing 116.

Isolation valves 178 and 180 are in fluid communication with the tee fittings 175 and 176, respectively, and thus with the high pressure tubing 116. In an exemplary embodiment, each of the valves 178 and 180 is a hydraulic plug valve. Fluid lines 182 and 184 are in fluid communication with the valves 178 and 180, respectively, and join at a fluid line 186. A choke 188 is fluidically positioned between the fluid line 186 and the relief valve 152. The valve 178 is in fluid communication with the relief valve 152 via at least the fluid line 182, the fluid line 186, and the choke 188. Similarly, the valve 180 is in fluid communication with the relief valve 152 via at least the fluid line 184, the fluid line 186, and the choke 188.

The sensor 158 is operably coupled to the fluid line 186, and is adapted to detect the pressure within the fluid line 186. However, in other embodiments, the sensor 158 can be operably coupled to any portion of the field pressure test control system 172 to enable pressure within the field pressure test control system 172 (or any particular component thereof) to be detected.

With continuing reference to FIG. 3, a tee fitting 190 is in fluid communication with the choke 188, and an isolation valve 192 is in fluid communication with each of the tee fitting 190 and the relief valve 152. The valve 192 is fluidically positioned between the tee fitting 190 and the relief valve 152. An isolation valve 194 is in fluid communication with the tee fitting 190. A fluid line 196 is in fluid communication with the valve 194, as well as with a fluid reservoir 198. In several exemplary embodiments, the fluid reservoir 198 is a pit or frac tank. The relief valve 152 is in fluid communication with the fluid line 196 via a fluid line 200.

When the valves 178 and 192 are open, the high pressure tubing 116 is in fluid communication with the relief valve 152 via at least the valve 178, the fluid line 182, the fluid line 186, the choke 188, the tee fitting 190, and the valve 192. Similarly, when the valves 180 and 192 are open, the high pressure tubing 116 is in fluid communication with the relief valve 152 via at least the valve 180, the fluid line 184, the fluid line 186, the choke 188, the tee fitting 190, and the valve 192. In several exemplary embodiments, the valves 178 and 180, when closed, fluidically isolate the high pressure tubing 116 from the remainder of the field pressure test control system 172.

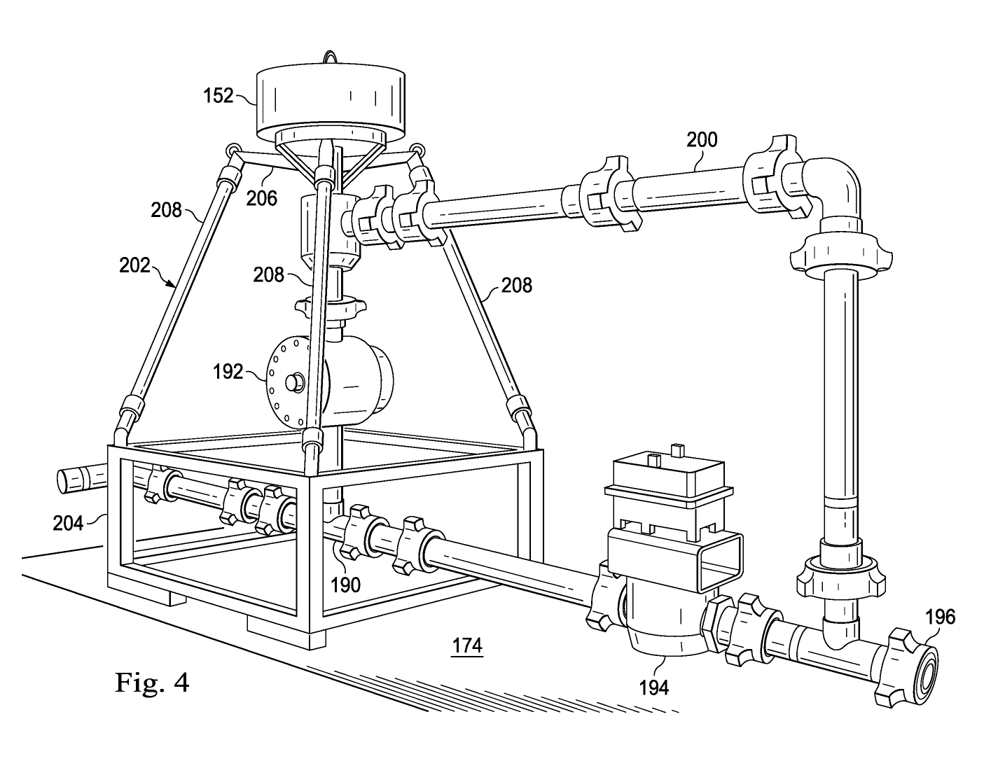

In an exemplary embodiment, as illustrated in FIG. 4 with continuing reference to FIGS. 1-3, a stand assembly 202 is mounted on the skid 174. The stand assembly 202 includes a base 204, an upper frame 206, and a plurality of structural supports 208 extending angularly upwardly from the base 204 to the upper frame 206. At least the tee fitting 190 is connected to the base 204, and the relief valve 152 is connected to the upper frame 206. As a result, the valve 192 is positioned vertically between the base 204 and the upper frame 206, with the structural supports 208 being spaced about the valve 192. In addition to the relief valve 152, the tee fitting 190, the valve 192, the valve 194, the fluid line 200, and at least a portion of the fluid line 196, are also mounted on the skid 174.

In several exemplary embodiments, each of the tee fittings 175, 176, and 190 may include, or be substituted with, one or more tee fittings, one or more other fittings, one or more pipes or tubulars, other flow iron, tubing or the like, one or more other components, or any combination thereof. In several exemplary embodiments, each of the fluid lines 177, 182, 184, 186, 196, and 200 may include one or more fittings, one or more pipes or tubulars, other flow iron, tubing, or the like, one or more other components, or any combination thereof. In several exemplary embodiments, one or more of the tee fittings 175, 176, and 190 may be combined in whole or in part with one or more of the fluid lines 177, 182, 184, 186, 196, and 200.

To operate the field pressure test control system 172, in an exemplary embodiment, the valves 178 and 180 are initially closed. The pressure within the high pressure tubing 116 is at zero psi. The well is closed at the wellhead 114. In several exemplary embodiments, the valve 192 is open and the valve 194 is closed. When the pressure within the high pressure tubing 116 is at zero psi, the valves 178 and 180 are opened so that the pressure relief valve 152 is in fluid communication with the high pressure tubing 116. A pressure threshold is set for the field pressure test control system 172. The pressure threshold may be set at any time either prior to the opening of the valves 178 and 180, or after the opening of the valves 178 and 180. In some exemplary embodiments, the pressure threshold may be set to a target pressure plus an additional amount of pressure. In several exemplary embodiments, the target pressure can represent, for example, a pressure that an operator anticipates the high pressure tubing 116 will experience during operation. In other exemplary embodiments, the pressure threshold can represent, for example, a desired pressure at which the relief valve 152 will open or be opened, and/or a pressure in excess of a target pressure that an operator desires the high pressure tubing 116 to be able to experience without failing. In an exemplary embodiment, the pressure threshold is set using the user interface 160 of the control box 154. In an exemplary embodiment, after being set, the pressure threshold is stored by the controller 162.

In an exemplary embodiment, when the pressure threshold is under 15,000 psi, the pressure threshold is the sum of the target pressure plus 500 psi (i.e., the additional amount of pressure added to the target pressure is 500 psi).

In another exemplary embodiment, to operate the field pressure test control system 172, the valves 178 and 180 are initially closed but, instead of the pressure within the high pressure tubing 116 being at zero psi, the pressure is less than a desired operating pressure, such as, for example, 5,000 psi or less. In several exemplary embodiments, when the pressure is not zero psi but is less than the desired operating pressure, the pressure threshold for the field pressure test control system 172 may be set before the valves 178 and 180 are opened so as to ensure that the relief valve 152 is not opened as a result of the opening of the valves 178 and 180.

After the pressure threshold has been set, and after the pressure within the high pressure tubing 116 is at either zero psi or a pressure that is less than the desired operating pressure, the pumps 112 begin pumping fluid into the high pressure tubing 116 and the pressure test control system 172 (because the valves 178 and 180 are open). Since the wellhead 114 is closed, and since the valves 178 and 180 are open, the continued pumping of fluid increases the pressure within the high pressure tubing 116 and the pressure test control system 172, including the fluid lines 182, 184, and 186, and the valves 178, 180, 192, and 152.

In an exemplary embodiment, once the pressure threshold has been reached as detected by the sensor 158, the pressure threshold is held for a desired duration of time. The desired duration of time can be pre-programmed into one or more components of the system 172 and/or can be remotely monitored by a user (e.g., via the control box 154). The desired duration of time can be any amount of time sufficient to pressure test the high pressure tubing 116, such as, for example, 5 minutes, 15 minutes, 30 minutes, 45 minutes, 1 hour, 2 hours, or more. The desired duration of time may depend upon one or more factors such as, for example, a length of the high pressure tubing 116, a material of the high pressure tubing 116, components coupled to the high pressure tubing 116, an estimated amount of time that the high pressure tubing 116 will experience pressure during operation, and/or one or more other factors.

The sensor 158 continues to detect the pressure within the fluid line 186, allowing operator(s) to remotely determine whether at least the high pressure tubing 116 is able to withstand pressure at the pressure threshold (which, in some embodiments, exceeds a target pressure that the high pressure tubing 116 will likely experience during operation) without failing, thereby pressure testing at least the high pressure tubing 116 of the frac site 100, as well as other component(s) that are in fluid communication with the high pressure tubing 116, such as those that may be upstream of the tee fitting 175 or downstream of the tee fitting 176. After the pressure threshold has been held by the high pressure tubing 116 for the desired duration of time, it can be determined whether the high pressure tubing 116 has passed the pressure test. In several exemplary embodiments, if the pressure threshold has been withstood or held by the high pressure tubing 116 for the desired duration of time, it is determined that the pressure test has been completed and that the high pressure tubing 116 has passed the pressure test.

After the pressure threshold is held for the desired duration of time, the valve actuation system 156 is activated to remotely open the relief valve 152. Since the valve actuation system 156 has been activated, the controller 162 causes the valve actuation system 156 to remotely open the relief valve 152. The valve actuation system 156 can be remotely activated by a user (e.g., via the control box 154) and/or automatically activated by the system 172 or components thereof, such as based on pre-programmed commands in the control box 154, the valve actuation system 156, and the like. Signals from the controller 162 can cause the valve actuation system 156 to remotely open the relief valve 152. In an exemplary embodiment, signals from the controller 162 so cause the valve actuation system 156 to remotely open the relief valve 152 because the sensor 158 has detected that the pressure within the line 186 is at the pre-stored pressure threshold for a desired duration of time. If the relief valve 152 is open, fluid can flow from the high pressure tubing 116, through the valves 178 and 180, the fluid lines 182, 184, and 186, the choke 188, the tee fitting 190, the valve 192, the relief valve 152, the fluid lines 200 and 196, and into the fluid reservoir 198. In several exemplary embodiments, the control box 154 is used to activate the valve actuation system 156; in several exemplary embodiments, the controller 162 of the control box 154 is used to activate the valve actuation system 156.

In several exemplary embodiments, when the relief valve 152 is opened, the choke 188 absorbs a large portion of the forces and wear caused by the fluid flow through the relief valve 152. Thus, in several exemplary embodiments, the choke 188 reduces the wear on the relief valve 152.

In several exemplary embodiments, since the relief valve 152 is remotely opened, human operator(s) are not required to be near the relief valve 152 during and/or after the pressure testing, thereby decreasing the risk of injury to the operator(s) and other personnel near the relief valve 152. In an exemplary embodiment, the controller 162 is remotely located from the pressure relief valve 152 by being positioned at a location that is equal to, or greater than, 15 feet away from the pressure relief valve 152. In an exemplary embodiment, the controller 162 is remotely located from the pressure relief valve 152 by being positioned at a location that is less than 15 feet away from the pressure relief valve 152.

In some embodiments, after the relief valve 152 has been remotely opened, the pumps 112 are shut down and the valves 178 and 180 are closed. In several exemplary embodiments, the valve 194 may be opened, after the valves 178 and 180 are closed, to ensure that the pressure in the remainder of the field pressure test control system 172 (e.g., the fluid lines 182, 184, 186, 196, 200, the choke 188, the tee fitting 190, the valves 192 and 194, the relief valve 152, etc.) is equal or nearly equal to the atmospheric pressure. The well is then opened at the wellhead 114. After the opening of the wellhead 114, normal operations may begin, with the pumps 112 pumping fluid to the wellhead 114 via at least the high pressure tubing 116. Since the valves 178 and 180 are closed during normal operations, fluid does not flow into the remainder of the field pressure test control system 172 (e.g., the fluid lines 182, 184, 186, 196, 200, the choke 188, the tee fitting 190, the valves 192 and 194, the relief valve 152, etc.). In several exemplary embodiments, the valves 178 and 180, when closed, fluidically isolate the high pressure tubing 116 from the remainder of the field pressure test control system 172.

In several exemplary embodiments, the field pressure test control system 172 allows operator(s) to remotely control the bleed-off of pressure during pressure test operations, and to bleed down the high pressure system after a frac stage.

In several exemplary embodiments, after a frac stage, the pressure within at least a portion of the high pressure tubing 116 (e.g., at least the fluid line 177) may be bled off by closing the valve 194, setting the pressure threshold of the system 172, and then opening the valves 178 and 180. The relief valve 152 may then be opened in accordance with any of the foregoing exemplary embodiments. As a result, fluid flows from the high pressure tubing 116 to the fluid reservoir 198, thereby bleeding off the pressure within the high pressure tubing 116.

In several exemplary embodiments, the field pressure test control system 172 safely allows the operator(s) to remotely relieve pressure within the high pressure tubing 116 and the system 172 without placing themselves or any other employee(s) at risk.

In several exemplary embodiments, except for the tee fittings 175 and 176, the fluid line 177, and the closed valves 178 and 180, the field pressure test control system 172 is fluidically isolated during fracing operations. In several exemplary embodiments, the field pressure test control system 172 is intended to be used for clean water operations, such as those in which the fracturing fluid has no sand or negligible sand. In several exemplary embodiments, the field pressure test control system 172 can handle limited amounts of residual sand remaining from previous frac stages. In several exemplary embodiments, the field pressure test control system 172 can be used for non-clean water operations (with sand).

In several exemplary embodiments, the field pressure test control system 172 allows for the pressure to be reduced to a desired pressure after a pressure test is complete. In some exemplary embodiments, a desired pressure to which the pressure is reduced is greater than zero psi. For example, the field pressure test control system 172 can permit pressure to be reduced sufficiently (such as, for example, to 5,000 psi) to permit the valves 178 and 180 to be closed to fluidically isolate the majority of the system 172 from the high pressure tubing 116, while the pumps 112 continue to pump fracturing fluid; the wellhead 114 may then opened and fluid pumping to the wellhead 114 may begin without reducing the pressure in the high pressure tubing 116 to zero psi.

In several exemplary embodiments, the frac site 100 of FIG. 1 includes the field pressure test control system 172 of FIGS. 3 and 4. In several exemplary embodiments, the frac site 100 of FIG. 1 includes the field pressure test control system 172 of FIGS. 3 and 4, with two relief valves 152 and two sensors 158 being positioned at the frac site 100, one of the relief valves 152 and one of the sensors 158 being configured substantially in accordance with FIGS. 1 and 2, and the other of the relief valves 152 and the other of the sensors 158 being configured substantially in accordance with FIGS. 3 and 4. In several exemplary embodiments, the frac site 100 of FIG. 1 includes the field pressure test control system 172 of FIGS. 3 and 4, with two relief valves 152 and two sensors 158 being positioned at the frac site 100, one of the relief valves 152 and one of the sensors 158 being configured substantially in accordance with FIGS. 1 and 2, and the other of the relief valves 152 and the other of the sensors 158 being configured substantially in accordance with FIGS. 3 and 4; in some exemplary embodiments, the two relief valves 152 and the two sensors 58 share the same actuation control box 154, the same valve actuation system 156, and the same fluid actuation source 170; in other exemplary embodiments, the two relief valves 152 and the two sensors 58 are operably coupled to different actuation control boxes 154, different valve actuation systems 156, and different fluid actuation sources 170.

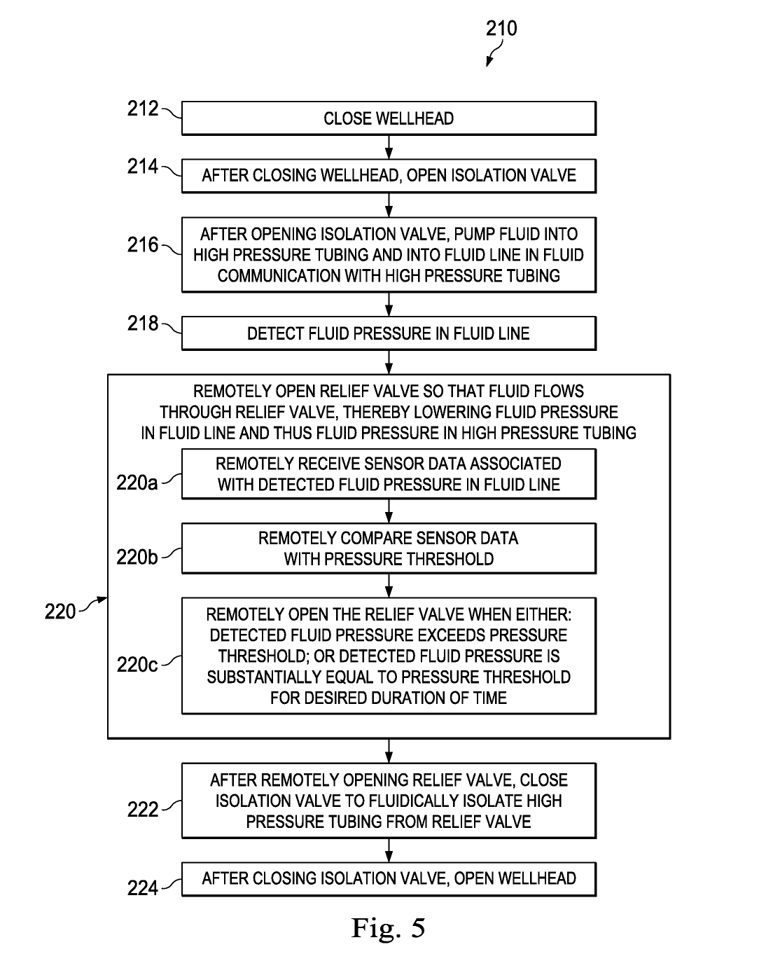

In an exemplary embodiment, as illustrated in FIG. 5 with continuing reference to FIGS. 1-4, a method of pressure testing high pressure tubing through which fluid is adapted to be pumped to a wellhead is generally referred to by the reference numeral 210 and includes a step 212, at which the wellhead is closed, that is, the oil or gas well, of which the wellhead is the surface termination, is closed at the wellhead at the step 212. After the step 212, an isolation valve is opened at step 214. After the step 214, at step 216 fluid is pumped into the high pressure tubing and into a fluid line that is in fluid communication with the high pressure tubing. Before, during, or after the step 216, fluid pressure in the fluid line is detected at step 218. Before, during, or after the step 218, at step 220 a relief valve is remotely opened so that the fluid flows through the relief valve, thereby lowering the fluid pressure in the fluid line and thus fluid pressure in the high pressure tubing. In several exemplary embodiments, the step 220 includes a step 220a, at which sensor data associated with the detected fluid pressure in the fluid line is remotely received. Before, during, or after the step 220a, at step 220b the sensor data is remotely compared with a pressure threshold. Before, during, or after the step 220b, at step 220c the relief valve is remotely opened when either the detected fluid pressure exceeds the pressure threshold or the detected fluid pressure is substantially equal to the pressure threshold for a desired duration of time. After the step 220, the isolation valve is closed at step 222 to fluidically isolate the high pressure tubing from the relief valve. After the step 222, at step 224 the wellhead is opened, that is, the oil or gas well is opened at the wellhead at the step 224.

In several exemplary embodiments, the method 210 may be implemented in whole or in part using the frac site 100, the relief valve system 150, the field pressure test control system 172, one or more components of the frac site 100, one or more components of the relief valve system 150, one or more components of the field pressure test control system 172, or any combination thereof. In several exemplary embodiments, the method 210 is a method of operating the system 172.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A field pressure test control system adapted to be operably coupled to high pressure tubing through which fluid is pumped to a wellhead, the field pressure test control system comprising:
a first isolation valve adapted to be in fluid communication with the high pressure tubing;
a first fluid line adapted to be in fluid communication with the high pressure tubing via at least the first isolation valve;
a sensor adapted to detect pressure in the first fluid line during pressure testing of the high pressure tubing; and
a pressure relief valve adapted to be in fluid communication with the high pressure tubing via at least the first fluid line and the first isolation valve;
wherein the pressure relief valve is adapted to change from a closed state to an open state to permit fluid flow through the pressure relief valve and thus lower pressure in the high pressure tubing after the pressure testing of the high pressure tubing.

2. The field pressure test control system of claim 1, further comprising:
a controller adapted to remotely control the change of the pressure relief valve from the closed state to the open state;
wherein the control of the change of the pressure relief valve from the closed state to the open state is at least partially based on the detected pressure in the first fluid line.

3. The field pressure test control system of claim 2, wherein the controller is configured to have a pressure threshold stored therein.

4. The field pressure test control system of claim 3, wherein the controller remotely controls the change of the pressure relief valve from the closed state to the open state when the detected pressure in the first fluid line is substantially equal to the pressure threshold for a desired duration of time.

5. The field pressure test control system of claim 3, wherein the controller is adapted to be in communication with the sensor;
wherein the controller is configured to receive from the sensor data associated with the detected pressure in the first fluid line, and to compare the data with the pressure threshold; and
wherein the controller remotely controls the change of the pressure relief valve from the closed state to the open state when either:
the detected pressure exceeds the pressure threshold; or
the detected pressure in the first fluid line is substantially equal to the pressure threshold for a desired duration of time.

6. The field pressure test control system of claim 2, wherein the controller is adapted to be positioned at a location that is equal to, or greater than, 15 feet away from the pressure relief valve.

7. The field pressure test control system of claim 1, further comprising:
a second isolation valve adapted to be in fluid communication with the first fluid line; and
a second fluid line adapted to be in fluid communication with each of the pressure relief valve, the second isolation valve, and a fluid reservoir;
wherein the second isolation valve is closed during the pressure testing of the high pressure tubing so that, after the pressure testing of the high pressure tubing, the fluid flows through the relief valve, through the second fluid line, and to the fluid reservoir.

8. The field pressure test control system of claim 7, further comprising:
a skid upon which at least the pressure relief valve, the second isolation valve, and at least a portion of the second fluid line are mounted.

9. The field pressure test control system of claim 1, further comprising:
a choke adapted to be fluidically positioned between the first isolation valve and the relief valve;
wherein the choke is adapted to absorb forces caused by the fluid flow through the pressure relief valve, thereby reducing wear on the pressure relief valve.

10. A method of pressure testing high pressure tubing through which fluid is adapted to be pumped to a wellhead, the method comprising:
closing the wellhead;
after closing the wellhead, pumping fluid into the high pressure tubing and into a fluid line that is in fluid communication with the high pressure tubing;
detecting a fluid pressure in the fluid line;
and
remotely opening a relief valve so that the fluid flows through the relief valve, thereby lowering the fluid pressure in the fluid line and thus fluid pressure in the high pressure tubing.

11. The method of claim 10, further comprising:
opening an isolation valve so that the high pressure tubing is in fluid communication with the fluid line via at least the isolation valve, wherein the isolation valve is opened before the fluid is pumped into the high pressure tubing and the fluid line;
and
closing the isolation valve to fluidically isolate the high pressure tubing from the relief valve, wherein the isolation valve is closed after the relief valve is remotely opened.

12. The method of claim 11, further comprising:
opening the wellhead;
wherein the isolation valve is closed before the wellhead is opened.

13. The method of claim 10, further comprising:
absorbing, using a choke in fluid communication with the relief valve, forces caused by the fluid flow through the relief valve, thereby reducing wear on the relief valve.

14. The method of claim 10, wherein remotely opening the relief valve comprises remotely opening the relief valve when the detected pressure in the fluid line is substantially equal to a fluid pressure threshold for a desired duration of time.

15. The method of claim 10, wherein remotely opening the relief valve comprises:
remotely receiving sensor data associated with the detected pressure in the fluid line;
remotely comparing the sensor data with a pressure threshold; and
remotely opening the relief valve when either:
the detected pressure exceeds the pressure threshold; or
the detected pressure in the first fluid line is substantially equal to the pressure threshold for a desired duration of time.

16. A method of lowering pressure in high pressure tubing through which fluid is adapted to be pumped to a wellhead, the method comprising:
connecting an isolation valve to the high pressure tubing;
closing the wellhead;
after closing the wellhead, opening the isolation valve so that the high pressure tubing is in fluid communication with a pressure relief valve;
after opening the isolation valve, detecting pressure in a fluid line, the fluid line being in fluid communication with the high pressure tubing via at least the open isolation valve; and
remotely controlling the pressure relief valve to lower the pressure in the high pressure tubing;
wherein the remote control of the pressure relief valve is based on at least the pressure detected in the fluid line.

17. The method of claim 16, further comprising:
closing the isolation valve; and
after closing the isolation valve, opening the wellhead.

18. The method of claim 16, wherein remotely controlling the pressure relief valve comprises remotely opening the pressure relief valve to permit fluid to flow through the pressure relief valve.

19. The method of claim 18, further comprising:
absorbing, using a choke in fluid communication with the relief valve, forces caused by the fluid flow through the relief valve, thereby reducing wear on the pressure relief valve.

20. The method of claim 18, wherein remotely opening the relief valve comprises:
remotely receiving sensor data associated with the detected pressure in the fluid line;
remotely comparing the sensor data with a pressure threshold; and
remotely opening the relief valve when either:
the detected pressure exceeds the pressure threshold; or
the detected pressure in the first fluid line is substantially equal to the pressure threshold for a desired duration of time.
